(19) United States
(12) Patent Application Publication
(10) Pub. No.: US 2019/0029385 A1
(43) Pub. Date: Jan. 31, 2019

(54) YOGA MAT CARRIER

(71) Applicant: Alea Deeter, Clearwater, FL (US)

(72) Inventor: Alea Deeter, Clearwater, FL (US)

(21) Appl. No.: 15/663,970

(22) Filed: Jul. 31, 2017

(51) Int. Cl. A45C 13/38; A63B 71/00; B62B 3/10

(52) U.S. Cl. CPC A45C 13/385; A63B 71/0036; B62B 5/067; B62B 2202/02; B62B 2202/40; B62B 3/104

(57) ABSTRACT

A yoga mat carrier that includes: a cylindrical body; a strap attachment at each end of the cylindrical body; a sleeve on the cylindrical body; a plurality of pockets on the cylindrical body; and a pull cart, wherein the pull cart supports the cylindrical body. The pull cart includes an extendable handle, where the sleeve fits over the extendable handle. Further features of the pull cart includes a base and a set of wheels, where the base supports the cylindrical body. The plurality of pockets may includes a towel pocket and other pockets for accessories related to the yoga practice. A bottle holder is provided on the cylindrical body to hold a water bottle.

### BACKGROUND OF THE INVENTION

### Field of Invention

The present invention relates to a yoga mat carrier used to store and transport yoga mats.

### Description of Related Art

Many individuals exercise and enjoy yoga as a physical practice to increase flexibility and further to reduce stress and/or anxiety. Yoga practice is usually performed in a studio or also can be performed at an individual's home. Yoga includes a series of stretching poses that are achieved through a sequence of movements associated with the practice of yoga. The user usually uses a mat to engage in yoga. Most yoga is performed barefooted therefore proper cushioning is needed for an individuals' hands and feet while engaging in yoga. Further some practices of yoga specifically require a mat due to the level of intensity that may be associated with yoga practices. As a result users that engage in yoga must transport their own yoga mat many times for their yoga class. The yoga mat normally can weigh 2 to 7 pounds and some yoga mats may come with bags or containers to house and store the bag for transport. As a result, it would be advantageous to have a rolling carrier so that the user can easily transport the yoga mat to their particular yoga class.

### SUMMARY OF THE INVENTION

The present invention relates a yoga mat carrier that includes: a cylindrical body; a strap attachment at each end of the cylindrical body; a sleeve on the cylindrical body; a plurality of pockets on the cylindrical body; and a pull cart, wherein the pull cart supports the cylindrical body. The pull cart includes an extendable handle, where the sleeve fits over the extendable handle. Further features of the pull cart includes a base and a set of wheels, where the base supports the cylindrical body. The plurality of pockets may includes a towel pocket and other pockets for accessories related to the yoga practice. A bottle holder is provided on the cylindrical body to hold a water bottle.

### BRIEF DESCRIPTION OF DRAWINGS

FIG. 1 shows a yoga mat carrier in accordance with the present invention.

FIG. 2 depicts a various view of the yoga mat carrier in accordance with the present invention.

FIG. 3 depicts the yoga mat carrier on a transport cart.

FIG. 4 depicts the transport cart used with the yoga mat carrier.

### DETAILED DESCRIPTION

The present invention relates to a yoga mat carrier that provides a means to store and transport a yoga mat within a sealed container. The yoga mat carrier is used in conjunction with a wheeled cart that has handles, a base and wheels to support the yoga mat during transport. A sleeve is provided to slide the carrier over the extended handle over the pull cart associated with the yoga mat carrier. A pull cart includes a base with wheels and an extendable handle. The carrier has a cylindrical body that is zipped closed and then zipped open to allow access to the interior of the cylindrical body. Other features of the yoga mat carrier includes a pocket for various accessories normally associated with a yoga class and attachment ends that allow for the attachment of a strap so that the carrier may be used without the pull cart.

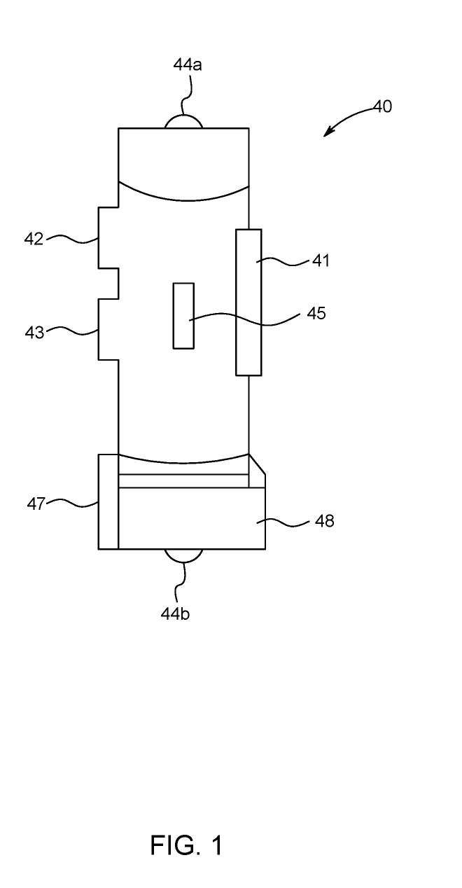

In reference to FIG. 1, a side view of the yoga mat carrier 40 is depicted. The yoga mat carrier 40 is shown as a substantially cylindrical body with strap attachments 44a, 44b at each end of the cylindrical body. Pockets are provided along the surface of the cylindrical body where two pockets are provided on one side of the mat carrier and a single larger pocket is on the opposing side. The first pocket 42 may be a fabric type pocket for storage of light items. A closed top pocket 43 is also shown to have a closure means to secure the pocket in a closed position. Many times, yoga practitioners use a towel during and after yoga practice, a towel pocket 41 is provided on the opposing side of the yoga mat carrier 40.

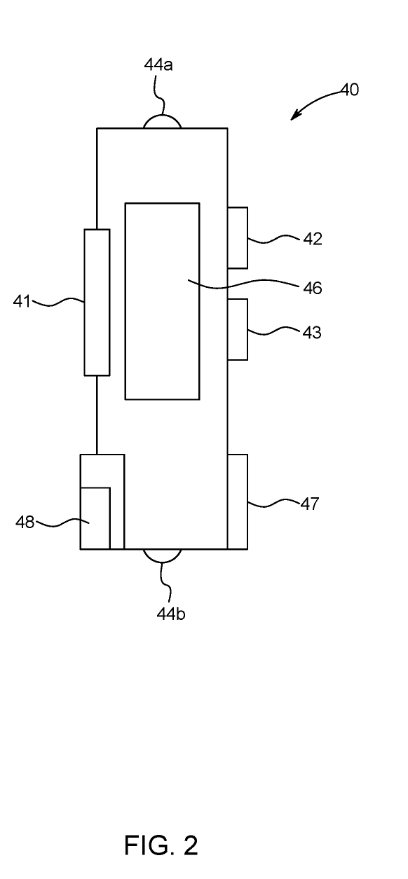

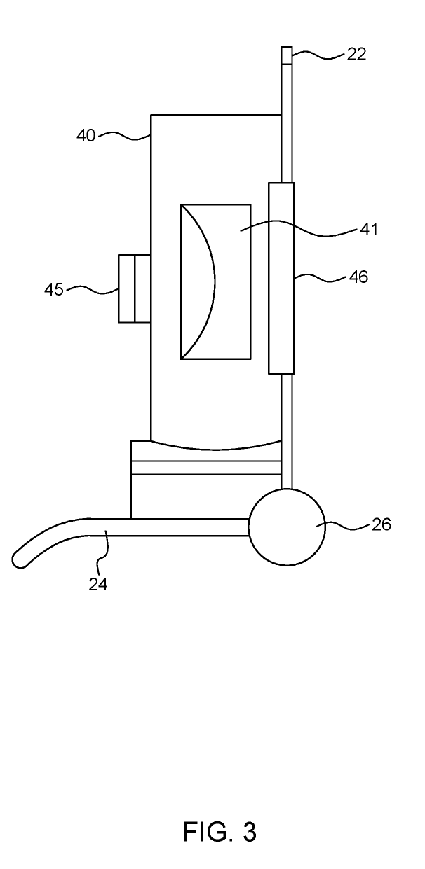

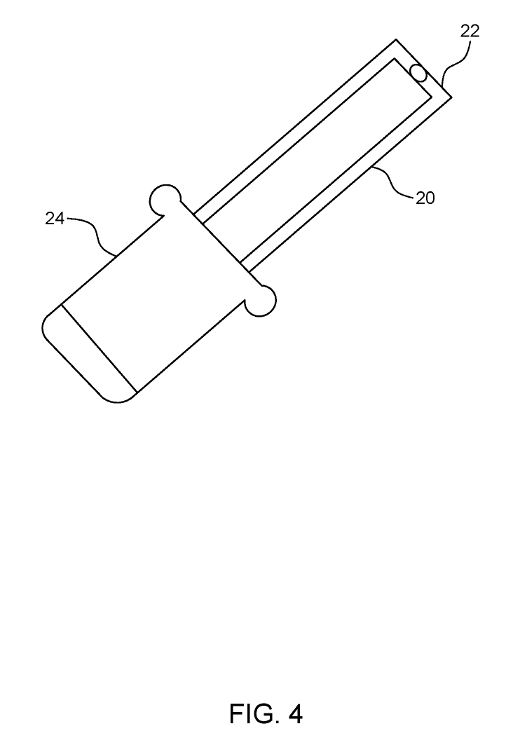

At the lower end of the yoga mat carrier 40 shown in FIG. 1 a mesh pocket 48 is shown next to the bottle holder 47. FIG. 2 depicts an opposing side view of the yoga mat carrier 40. This side view shows a sleeve 46 that is used to attach a pull cart 20. FIGS. 3 and 4 depict the pull cart 20 that is used to pull the yoga mat carrier 40. As shown in FIG. 3, the yoga mat carrier 40 is placed on the pull cart 20. The pull cart 20 includes an extendable handle 22 and base 24. The handle 22 is adapted to receive the sleeve 46 of the mat carrier 40. FIG. 4 depicts the pull cart 20 separately, where the base 24 is shown extending from the base. The user simply places a yoga mat within the carrier 40 and closes the carrier 40 for transport.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A yoga mat carrier comprising:
a. a cylindrical body;
b. a strap attachment at each end of the cylindrical body;
c. a sleeve on the cylindrical body;
d. a plurality of pockets on the cylindrical body, wherein the plurality of pockets include two pockets on one side of the cylindrical body and a single pocket on an opposing side; and
e. a pull cart, wherein the pull cart supports the cylindrical body.

2. The yoga mat carrier according to claim 1, where the pull cart includes an extendable handle.

3. The yoga mat carrier according to claim 2, where the sleeve fits over the extendable handle.

4. The yoga mat carrier according to claim 2, where the pull cart includes a base and a set of wheels.

5. The yoga mat carrier according to claim 1, where the single pocket is a towel pocket.

6. The yoga mat carrier according to claim 1, where a bottle holder is provided on the cylindrical body.
